(19) United States
(12) Patent Application Publication
(10) Pub. No.: US 2007/0052910 A1
(43) Pub. Date: Mar. 8, 2007

(54) Liquid crystal display panel

(76) Inventors: De-Jiun Li, Jhonghe City (TW); Der-Chun Wu, Linkou Township (TW)

Correspondence Address: J C PATENTS, INC., 4 VENTURE, SUITE 250, IRVINE, CA, 92618, US

(21) Appl. No.: 11/222,706

(22) Filed: Sep. 8, 2005

(51) Int. Cl. G02F 1/1339

(52) U.S. Cl. 349/155

(57) ABSTRACT

A liquid crystal display panel, including a first substrate, a second substrate, a liquid crystal layer and a spacer is provided. The second substrate is disposed over the first substrate, and the liquid crystal layer is disposed between the first substrate and the second substrate. The spacer is also disposed between the first substrate and the second substrate, for sustaining a gap between the first substrate and the second substrate. The spacer is composed of a plurality of support structures seated on the same base, and each support structure has a first portion and a second portion. The first portions of the adjacent support structures are connected with each other, and the second portions of the adjacent support structures are spaced out a distance. The spacer can disperse external pressures so as to improve the yield in assembling process of the liquid crystal display.

### BACKGROUND OF THE INVENTION

1. Field of the Invention

The invention relates to a display panel, and more particularly to a liquid crystal display panel with a yield improved in assembling process thereof.

2. Description of the Related Art

The fast development of a multi-media society is benefited from the huge progress of semiconductor components and display devices. For display devices, the Liquid Crystal Display (LCD) gradually dominates the display market, with such features as high resolution, good space utility rate, low power consumption and zero radiation.

FIG. 1 is cross-sectional view of a conventional Liquid Crystal Display panel. In the FIG. 1, the Liquid Crystal Display panel 100 comprises a bottom substrate 110, a liquid crystal layer 120, and a top substrate 130. Wherein, the liquid crystal layer 120 is sealed between the bottom substrate 110 and top substrate 130 by a sealant (not shown). In addition, since the features of liquid crystal display device, such as response speed, contrast value and view angle, are closely related to the cell gap d, the cell gap d is tightly controlled according to the optical characteristic of the liquid crystal materials. Besides, if there are different gaps d in the device, the displayed image could easily be uneven and the precision of picture could be lowered. Thus a spacer 102 is usually disposed between the bottom substrate 110 and the top substrate 130 for keeping the cell gap d.

According to present technology, since a pillar-shaped spacer can provide more even cell gaps, better transparent ratio and higher contrast for display panel, it has replaced the original ball-shaped spacer. For the panel to bear more stress or vibration, a conventional method is to increase the unit area number of the spacer, or to design block-shaped spacers to enhance the support. However, in such a method, the top and bottom substrates could not be appropriately squeezed due to the rigidity of the plurality of spacers during the assembly process, and the yield in assembling process of the liquid crystal one drop fill (ODF) process is further reduced, leading to gas bubble or liquid crystal vertical flow phenomenon.

### SUMMARY OF THE INVENTION

Accordingly, the purpose of the invention is to provide a liquid crystal display panel, in which the spacer not only provides strong support but also deforms as sustaining the pressure during an assembly process of a liquid panel display, thereby increasing a process yield in the manufacturing process of the liquid panel display.

The invention provides a liquid crystal display panel comprising a first substrate, a second substrate, a liquid crystal layer and a plurality of spacers. At this structure, the second substrate is disposed over the first substrate, and the liquid crystal layer is disposed between the first substrate and the second substrate. In addition, the plurality of spacers is also disposed between the first substrate and the second substrate for keeping a gap between the first substrate and the second substrate. The plurality of spacers includes a plurality of support structures, and each of the support structures has a first portion and a second portion. The first portions of the plurality of support structures are connected and adjacent with each other, and the second portions of the plurality of support structures are adjacent with each other to space out a distance.

In some embodiments of the present invention, the minimum height of the second portion of each support structure is ¼ of the total height of each support structure while the maximum height of the second portion of each support structure is ¾ of the total height of each support structure.

In some embodiments of the present invention, the support structures are pillar-shaped. For example, the support structures are any of the round pillars, oval pillars, cross-shaped pillars, L-shaped pillars, regular polygon or irregular polygon pillars.

In some embodiments of the present invention, the distance between the second portions of neighboring support structures is longer than a maximum lateral deformation value of the second portions of the support structures. For example, the distance between the second portions of the support structures is ½ of the width of the second portions of the support structures.

The invention provides a liquid crystal display panel comprising a first substrate, a second substrate, a liquid crystal layer and a plurality of spacers. At this structure, the second substrate is disposed over the first substrate, and the liquid crystal layer is disposed between the first substrate and the second substrate. In addition, the plurality of spacer is also disposed between the first substrate and the second substrate for keeping a gap between the first substrate and the second substrate. The plurality of spacers has a plurality of protrusions contacting with the first substrate or the second substrate respectively.

In some embodiments of the present invention, the minimum height of the protrusions is ¼ of the height of the plurality of spacers while the maximum height of the protrusions is ¾ of the height of the plurality of spacers.

In some embodiments of the present invention, the protrusions are pillar-shaped. For example, the support structures are any of the round pillars, oval pillars, cross-shaped pillars, L-shaped pillars, regular polygon or irregular polygon pillars.

In some embodiments of the present invention, the distance between the protrusions is longer than a maximum lateral deformation value of the protrusions. For example, the distance between the protrusions is ½ of the width of the protrusions.

In some embodiments of the present invention, the first substrate, for example, is an active element array substrate, such as a thin film transistor array substrate. The second substrate, for example, is a color filter. In some embodiments of the invention, the first portions of these support structures are disposed on the color filter, and the color filter includes a black matrix, on which the spacer is disposed.

In some embodiments of the present invention, the liquid crystal display panel further comprises a sealant, which is disposed between the first substrate and second substrate and seals the liquid crystal layer among the first substrate, the sealant and the second substrate. Besides, in one embodiment, the plurality of spacers is disposed between the sealant and the liquid crystal layer.

The plurality of spacers of the present invention not only increase the process yield of the ODF, but also evenly disperse the outward pressure to prevent damage of the two substrates.

### BRIEF DESCRIPTION OF THE DRAWINGS

FIG. 1 is a cross-section view of a conventional liquid crystal display panel.

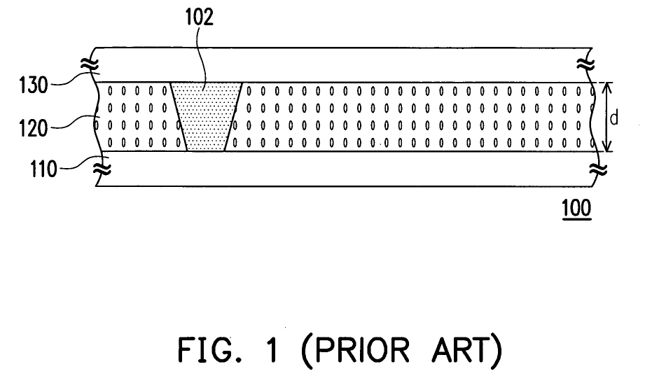

FIG. 2 is a cross-sectional view of a liquid crystal display panel according to one embodiment of the present invention.

FIG. 3 is a cross-section view of a liquid crystal display panel according to another embodiment of the present invention.

FIG. 4 is a side view of a spacer according to the embodiment of the present invention.

FIG. 5 to FIG. 7 are top views of the spacer according to an embodiment of the present invention.

FIG. 8 and FIG. 9 are relationship charts between support areas and compression ratios of the plurality of spacers in two embodiments of the present invention and in the prior art.

FIG. 10 is a partial top view of a color filter according to one embodiment of the present invention.

FIG. 11 is a cross-sectional view of assembling a liquid crystal display panel according to one embodiment of the present invention.

FIG. 12A to FIG. 12C are top views of the spacer in FIG. 11.

### DETAILED DESCRIPTION OF THE EMBODIMENTS

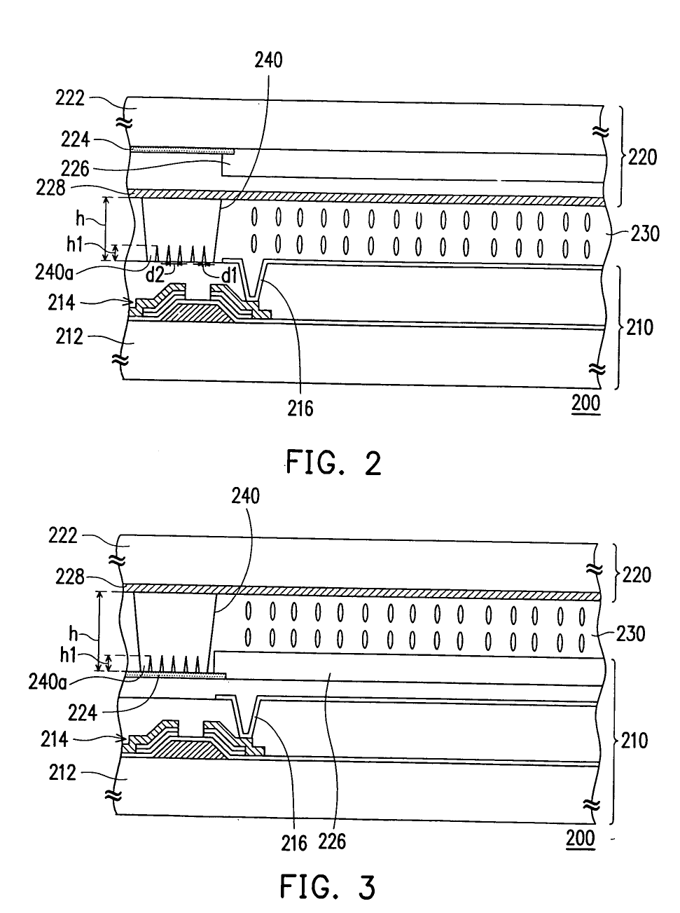

FIG. 2 is a cross-sectional view of the liquid crystal display panel according to one embodiment of the present invention. Referring to FIG. 2, the liquid crystal display panel 200 comprises a first substrate 210, a second substrate 220, a liquid crystal layer 230 and a spacer 240. The second substrate 220 is disposed over the first substrate 210. In the embodiment of present invention, the first substrate 210 is an active element array substrate comprising a transparent plate 212, a plurality of active elements 214 and pixel electrodes 216 thereon. Further, since thin film transistor (TFT) has good response speed, in this embodiment, TFTs are used as the active elements 214 for driving the liquid crystal display panel 200. In other words, the first substrate 210 is preferred to be a thin film transistor array substrate in the embodiment.

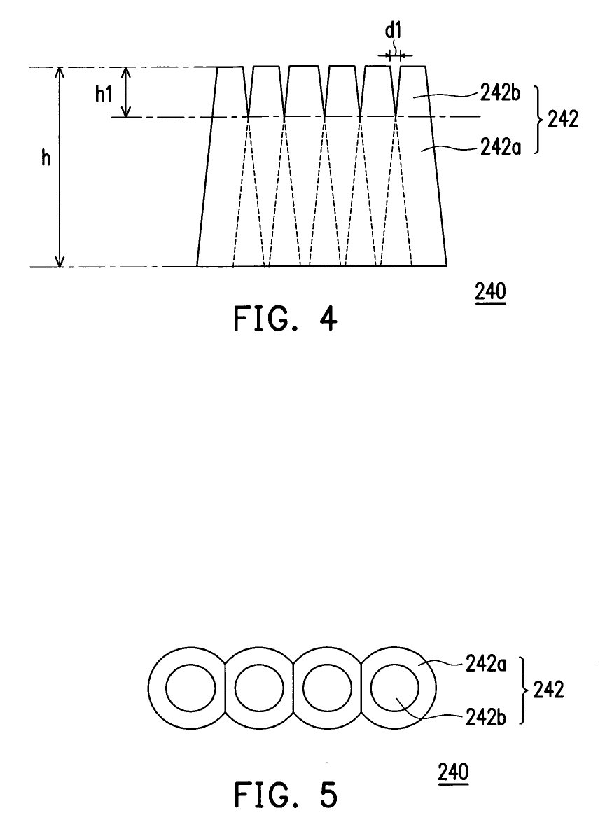

The second substrate 220 is a color filter, for example, comprising a transparent plate 222, a black matrix 224, a color filter layer 226 and a common electrode 228 thereon. It is known to people skilled in the art that the color filter layer on the thin film transistor array (Color Filter on Array, COA) technology has been used in many liquid crystal display panels, and the present invention dose not limit the first substrate 210 and the second substrate 220 to the above module. As show in FIG. 3, the first substrate 210 might be a substrate with a color filter layer on the active element array, and the second substrate 220 may comprise a transparent plate 222 and a common electrode 228.

In FIG. 2, the liquid crystal layer 230 is disposed between the first substrate 210 and the second substrate 220, and the spacer 240 is also disposed between the first substrate 210 and the second substrate 220 for keeping a gap between the first substrate 210 and the second substrate 220 (i.e. the cell gap of the liquid crystal display panel 200). The spacer 240 has a plurality of protrusions 240a, and the distance d₁ between the protrusions 240a, for example, is longer than the lateral deformation value of the protrusions 240a. For example, d₁ is longer than ½ of width d₂ of the protrusions 240a, and the width d₂ is 1.2 micro meters, for example.

Additionally, because the spacer 240 is formed on the color filter in this embodiment, that is, so-called SOC technique, the protrusions 240a of the spacer 240, for example, is contacted with the first substrate 210. Certainly, the spacer 240 can be formed on the active element array substrate by one of ordinary skill in the art, and the protrusions 240a of the spacer 240 is contacted with the second substrate 220 (not shown).

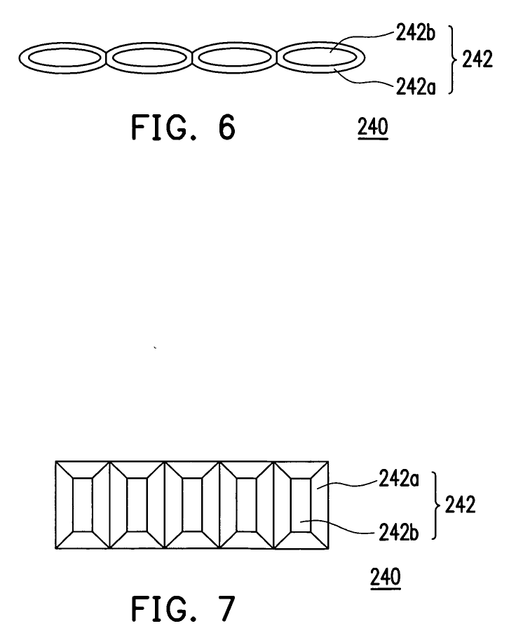

FIG. 4 is a side view of a spacer according to one embodiment of the present invention. Referring to FIG. 4, it should be noted that spacer 240, for example, comprises a plurality of support structures 242. Each of the support structures 242 has a first portion 242a and a second portion 242b. The first portions of the support structures 242 are connected with each other, and the second portions are spaced from each other with a distance d₁. It can be understood from the above disclosure that, the protrusions 240a of the spacer 240 in FIG. 2 and FIG. 3 are composed of the second portions 242b of the support structures 242. In other words, the first portions 242a of the support structure 242 are formed on the color filter in SOC technique.

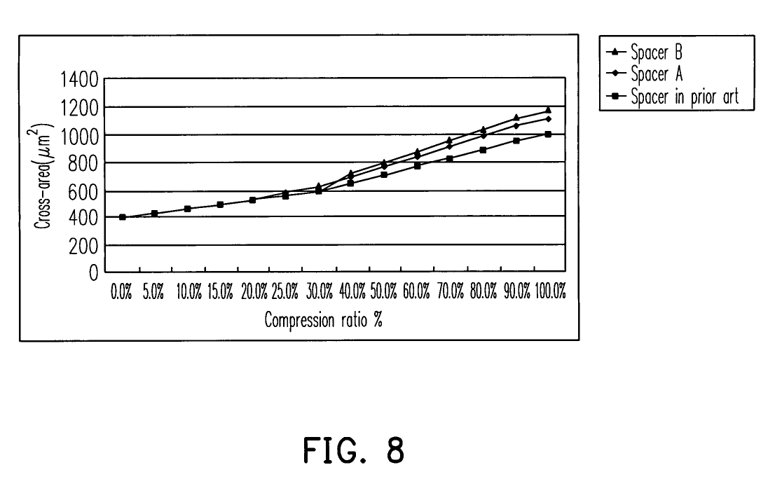

Specially, the support structures 242, for example, are pillars, and the first portions 242a and/or second portions 242b may be round pillars (FIG. 5), oval pillars (FIG. 6), trapezoid pillars (FIG. 7), or regular and other irregular polygon pillars (not shown). The invention does not limit its shape. Besides, the material of the spacer 240 can as photo-sensitive material, which is formed by patterning a photosensitive layer (not shown) in an exposure and developing process. The height h₁ of the second portions 242b (that is the protrusions 240a of the spacer 240) of the support structures 242 are determined by the material of the spacer, and the developer, and developing time during the developing process.

Note that the height h₁ of the second portion 242b of each support structure 242 is larger than or equals to ¼ of total height h of the support structure 242 (0.3 micro meter, for example). That is, the height h₁ of each protrusion 240a is larger than or equals to ¼ of the total height h of the spacer 240, so that the spacer 240 has flexibility. When the first substrate 210 and the second substrate 220 bear external pressures, the spacer 240 can be deformed. As a result, during the assembly process, the liquid crystal display 200 can be easily squeezed to have suitable cell gap. On the other hand, the height h₁ of each protrusion 240a is smaller than or equals to ¾ of the total height h of the spacer 240, to prevent the spacer 240 from tilting or breaking when the liquid display panel 200 bears too much pressure.

As described above, the spacer in the present invention comprises many partially overlapping support structures, so the overlapping ratio can be controlled to increase the bottom area of the spacer, or reduce the top area of the spacer, to have preferred support and process yield for manufacturing the liquid crystal display. The following are examples with simulation data.

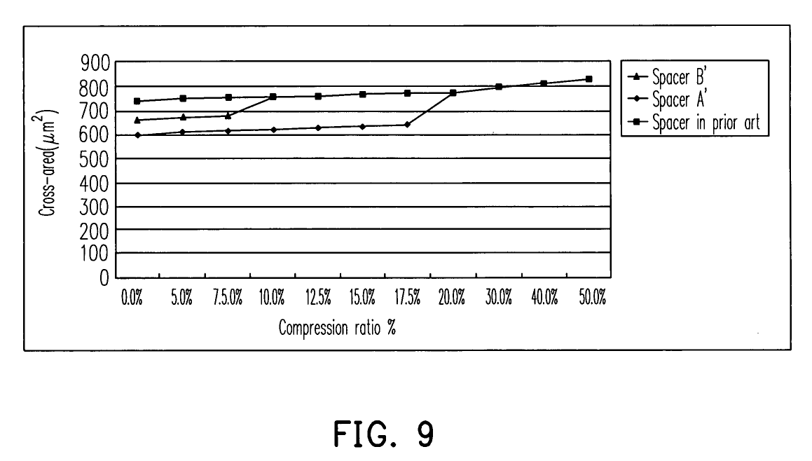

FIG. 8 is a relationship chart between support area and compression ratio of the plurality of spacers according to one embodiment of the present invention and in the prior art. Note that the conventional trapezoid spacer with a bottom area of 1000 μm² and a top area of 400 μm² is the reference, which is cared with spacers A, B of different cross section areas in the present invention. Wherein, spacer A comprises four support structures with top area of 100 m², and the overlapping ratio of the bottoms of the four support structures is 80%. In other words, spacer A has the same top area as the conventional one, and the bottom area is 1,120 μm², for example. The spacer B also comprises four support structures with bottom overlapping ratio of 70%, and the bottom area of the spacer B is 1180 μm², for example.

As show in FIG. 8, under the same compression ratio, the support area of the spacer B is the largest, the support area of the conventional spacer is the smallest, and the support area of the spacer A is in the middle. Therefore, when it is not suitable to change the top area of the spacer, the bottom area can be increased to enlarge the support area of the spacer, further to enhance the support ability of the plurality of spacers so the liquid crystal display maintains a specific cell gap. Besides, the spacer in the present invention comprises several support structures, and the tops of the support structures are not connected. Compared with the conventional trapezoid spacer with the same top area, the spacer in the present invention is more flexible so as to deform without breaking or falling when bearing slight pressure.

Moreover, the present invention can control the overlapping ratio of the support structures to reduce the top area of the spacer, thus increasing the flexibility of the spacer. FIG. 9 is a relationship chart between support area and compression ratio of the plurality of spacers according to another embodiment of the present invention and in the prior art. Wherein, the top area of the spacer A′ is 81% of the top area of the conventional spacer, and the top area of the spacer B′ is 89% of the top area of the conventional spacer. In addition, the bottom areas of the three spacers are the same.

From FIG. 9, with same compression ratio, the spacer A′ has the smallest top area, then the spacer B′ and the conventional spacer has the biggest top area. That is, spacer A has the most flexibility, followed by the spacer B′. Therefore, when the spacer A′ and spacer B′ bear the pressure, the bottoms thereof can provide the equal amount of support as the conventional one, and the tops thereof have better flexibility, so as to prevent breaking or falling.

More particularly, due to the flexibility of the spacer A′ and B′, in the assembly process of the liquid crystal display panel, panel can be properly squeezed to keep a suitable cell gap. In other words, the present invention can improve the process yield of the one drop fill (ODF) process of liquid crystal display panel, to avoid liquid crystal vertical flows or bubbles.

Also note that in the present invention, the liquid crystal display panel can be disposed with spacers of different heights according to the film thickness of the two substrates, so as to increase the process yield and maintain the suitable cell gap when the panel sustains outward pressure.

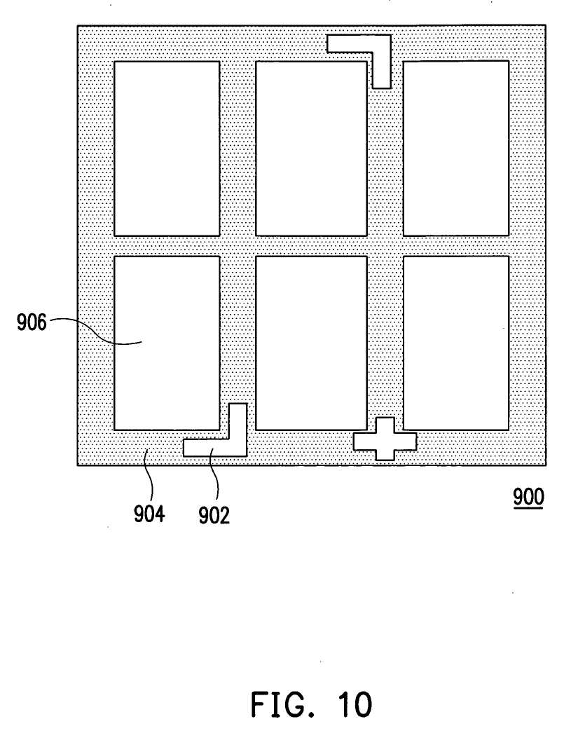

FIG. 10 is a partial top view of a color filter in an embodiment of the invention. Referring to FIG. 10, in the SOC technology, the spacer 902 is disposed corresponding to the black matrix 904 of color filter 900. To avoid reducing the aperture ratio of the color filter 900, the spacer 902 with larger bottom area can be disposed along the corner of the rectangular color filter layer 906. Wherein, the spacer 902 of the embodiment is, for example, a cross-shaped pillar or an L-shaped pillar.

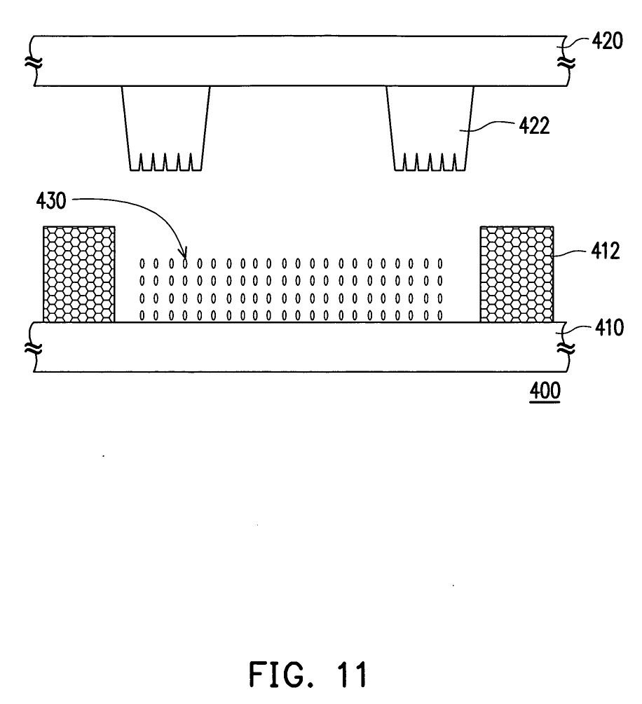

FIG. 11 is a cross-sectional view of the assembly process of a liquid crystal display panel in an embodiment of the invention. In FIG. 11, in an ODF process, the first step is to form the first substrate 410 and second substrate 420 for the liquid crystal display panel 400. Wherein, the spacer 422, for example, is formed with second substrate 420 synchronously, and then the sealant 412 is applied on the first substrate 410.

Next, a liquid crystal layer 430 is formed in the area enclosed by the sealant 412 on the first substrate 410 in an ODF process. Then the second substrate 420 is disposed on the first substrate 410, and the two substrates are pressed such that the liquid crystal layer 430 is sealed between the first substrate 410, the sealant 412 and second substrate 420. Finally, the sealant 412 is irradiated by UV light to cure it.

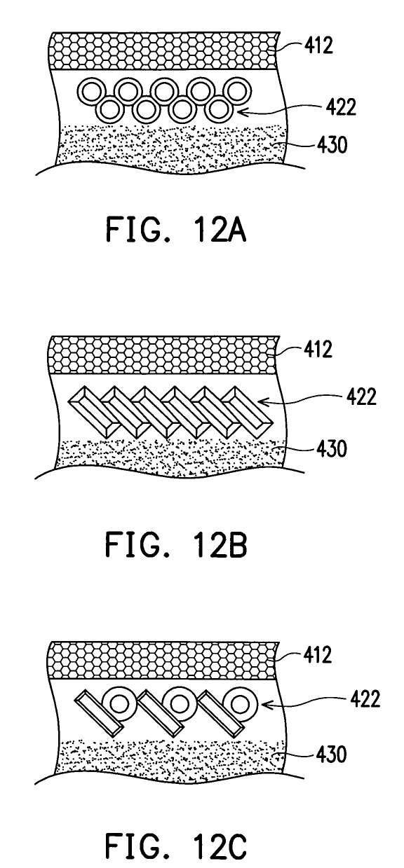

In fact, after the liquid crystal layer 430 is dropped, if some liquid crystal molecules move too fast, and get in touch with the un-solidified sealant 412, the liquid crystal layer 430 would be contaminated and the yield is reduced. Therefore, in an embodiment of the invention, the spacer 422 is disposed between the sealant 412 and the liquid crystal layer 430, arranged in the shape shown in FIG. 12A to FIG. 12C to reduce the liquid crystal molecules flowing speed, such that liquid crystal molecules do not contact with un-solidified sealant 412, and the yield can be raised.

The present invention utilized support structures whose bottoms are connected to serve as spacers for the liquid crystal display panel so as to enhance the support ability of the spacer by the connecting bottom, and to disperse the outward pressure to avoid damage of the devices due to concentrated pressure. Therefore, in the present invention the density of the support structures need not increased for the panel to have enough support.

Besides, these support structures have enough flexibility so the plurality of spacers can deform when bearing outward pressure. Especially in the ODF process, these flexible support structures enables the panel to be squeezed with proper cell gap to have a good process yield, such that liquid crystal vertical flow or bubbles can be prevented.

In conclusion, the plurality of spacers in the present invention not only increases the process yield of the ODF, but also evenly disperses the outward pressure when the liquid crystal display panel is assembled or during the pressure test, to avoid the damage of deices on the two substrates due to pressure. Moreover, if the plurality of spacers is disposed between the sealant and the liquid crystal layer, this can prevent the liquid crystal molecules to contact with the unsolid sealant and avoid the liquid crystal layer from being contaminated and having worsening optical properties.

While the present invention has been described with embodiments, this description is not intended to limit the invention. Various modifications of the embodiment will be apparent to those skilled in the art. It is therefore contemplated that the appended claims will cover any such modifications or embodiments as fall within the true scope of the invention.

What is claimed is:

1. A liquid crystal display panel, comprising:
a first substrate;
a second substrate, disposed over the first substrate;
a liquid crystal layer, disposed between the first substrate and the second substrate; and
at least one spacer, disposed between the first substrate and the second substrate, for keeping the gap between the first substrate and the second substrate, the spacer comprising a plurality of support structures, each of the support structures has a first portion and a second portion, the first portions of the adjacent support structures are connected with each other, and the second portions of the adjacent support structures are spaced out a distance.

2. The liquid crystal display panel of claim 1, wherein the minimum height of the second portion of each support structure is ¼ of a total height of each support structure.

3. The liquid crystal display panel of claim 1, wherein the maximum height of the second portion of each support structure is ¾ of a total height of each support structure.

4. The liquid crystal display panel of claim 1, wherein the support structures are pillar.

5. The liquid crystal display panel of claim 4, wherein the support structures comprise at least one of round pillars, oval pillars, cross-shaped pillars, L-shaped pillars, regular polygon pillars and irregular polygon pillars.

6. The liquid crystal display panel of claim 1, wherein the distances are longer than a maximum lateral deformation value of the second portions of the support structures.

7. The liquid crystal display panel of claim 1, wherein the distances between the neighboring support structures are longer than ½ of the width of the second portions of the support structures.

8. The liquid crystal display panel of claim 1, wherein the first substrate is an active element array substrate and the second substrate is a color filter.

9. The liquid crystal display panel of claim 8, wherein the first portions of the support structures are disposed on the color filter.

10. The liquid crystal display panel of claim 9, wherein the color filter comprises a black matrix, and the support structures are disposed corresponding to the black matrix.

11. The liquid crystal display panel of claim 8, wherein the active element array substrate is a thin film transistor array substrate.

12. The liquid crystal display panel of claim 1, further comprising a sealant, disposed between the first substrate and the second substrate, for sealing the liquid crystal layer between the first substrate, the sealant and the second substrate.

13. The liquid crystal display panel of claim 12, wherein the spacer is further disposed between the sealant and the liquid crystal layer.

14. A liquid crystal display panel, comprising:
a first substrate;
a second substrate, disposed over the first substrate;
a liquid crystal layer, disposed between the first substrate and the second substrate; and
at least one spacer, disposed between the first substrate and the second substrate, the spacer has a plurality of protrusions contacting with the first substrate or the second substrate.

15. The liquid crystal display panel of claim 14, wherein the protrusions are pillar.

16. The liquid crystal display panel of claim 15, wherein the protrusions comprise at least one of round pillars, oval pillars, cross-shaped pillars, L-shaped pillars, regular polygon pillars and irregular polygon pillars.

17. The liquid crystal display panel of claim 14, wherein the distances are longer than a maximum lateral deformation value of the protrusions.

18. The liquid crystal display panel of claim 14, wherein the distances between the neighboring support structures are longer than ½ of the width of the protrusions.

19. The liquid crystal display panel of claim 14, wherein the minimum height of the protrusions is ¼ of the height of the spacer.

20. The liquid crystal display panel of claim 14, wherein the maximum height of the protrusions is ¾ of the height of the spacer.

21. The liquid crystal display panel of claim 14, wherein the first substrate is an active element array substrate and the second substrate is a color filter.

22. The liquid crystal display panel of claim 21, wherein the spacer is disposed on the color filter.

23. The liquid crystal display panel of claim 22, wherein the color filter comprises a black matrix, and the spacer are disposed corresponding to the black matrix.

24. The liquid crystal display panel of claim 21, wherein the active element array substrate is a thin film transistor array substrate.

25. The liquid crystal display panel of claim 14, further comprising a sealant, disposed between the first substrate and the second substrate, for sealing the liquid crystal layer between the first substrate, the sealant and the second substrate.

26. The liquid crystal display panel of claim 25, wherein the spacer is further disposed between the sealant and liquid crystal layer.
